(19) United States
(12) Patent Application Publication
(10) Pub. No.: US 2024/0270100 A1
(43) Pub. Date: Aug. 15, 2024

(54) HIGH EFFICIENCY WIRELESS CHARGING SYSTEM FOR IN PLUG-IN ELECTRIC VEHICLES

(71) Applicants: MAGNA POWERTRAIN, INC., Aurora (CA); University of Tennessee Research Foundation, Knoxville, TN (US)

(72) Inventors: Hua Bai, Knoxville, TN (US); Liyan Zhu, Knoxville, TN (US); Ziwei Liang, Knoxville, TN (US); Yue Sun, Knoxville, TN (US); Headley Phillips, Kleinburg, Ontario (CA)

(21) Appl. No.: 18/568,528

(22) PCT Filed: Jun. 27, 2022
(86) PCT No.: PCT/US22/73181

§ 371 Date: Dec. 8, 2023

Related U.S. Application Data
(60) Provisional application No. 63/215,667, filed on Jun. 28, 2021.

(51) Int. Cl. B60L 53/22; B60L 53/122; B60L 58/20; H02J 7/00; H02J 7/34; H02J 50/12; H02J 50/40

(52) U.S. Cl. CPC B60L 53/22; B60L 53/122; B60L 58/20; H02J 7/00047; H02J 7/342; H02J 50/12; H02J 50/402; B60L 2210/10; B60L 2210/30; B60L 2210/40; H02J 2207/20

(57) ABSTRACT

A charger for a vehicle includes a power factor correction (PFC) stage to convert AC input power to DC power; an inverter stage; and a transformer having first, second, and OBC coils, each being magnetically coupled for transmitting power therebetween. The OBC coil is connected to the inverter stage, a high-voltage (HV) power converter is connected to the first coil to charge an HV battery connected thereto, and a low-voltage (LV) power converter is connected to the second coil to charge an LV battery connected thereto. The charger is operable in an onboard charger (OBC) mode to transfer the input power to charge the HV battery from the AC input power. The charger is also operable in a DC-DC mode to transfer power from the HV battery to the LV battery, and a wireless power transfer (WPT) mode to receive power from a transceiver coil for charging the HV battery.

### CROSS REFERENCE TO RELATED APPLICATIONS

This PCT international patent application claims the benefit of U.S. Provisional Patent Application No. 63/215,667, filed Jun. 28, 2021, the contents of which is incorporated herein by reference in its entirety.

### BACKGROUND

Different types and arrangements exist for charging the battery pack of a plug-in electric vehicle (EV) using a stationary source of electric power, typically provided by a connection to the electric grid. Plug-in EV chargers may be broadly categorized as Level 1, 2 or 3. Level 1 chargers use a standard single-phase outlet (120 VAC in North America) and take the longest time to charge the battery pack among three levels of chargers stated above. Level 2 chargers utilize a higher supply voltage (240 VAC in North America) and are typically sold by the auto manufacturers or other electrical supply equipment manufacturers for an additional cost ranging between $1000 and $3000. Level 2 charging usually takes between 2-4 hours to charge the battery pack of a typical plug-in EV. EV chargers may be provided as standalone units and/or integrated with an EV as an onboard charger (OBC).

Additionally, current electric vehicles (EVs) and plug-in hybrid electric vehicles (PHEVs) (plug-in electric vehicles) commonly use a separate auxiliary DC/DC converter in the vehicle to convert the high voltage DC power from the HV battery pack to low voltage (LV) DC power, such as 12-14 VDC, which is either stored in a LV DC battery or used to power electrical accessories such as radio, lights etc. in the vehicle.

Furthermore, wireless power transfer (WPT) may be used to supply power from a stationary source to an EV without a direct physical connection therebetween. An EV that obtains power from a stationary charger using WPT may still be called a plug-in EV, even if there is no physical plugging-in. This distinguishes such plug-in EVs from vehicles that obtain electrical power solely from an onboard source, such as an internal combustion engine (ICE).

Size and weight of EV chargers and WPT devices are important considerations. This is especially true for WPT and OBC components that are integrated with or otherwise transported with the EV.

### SUMMARY

The present disclosure provides a charger circuit for a vehicle. The charger circuit includes a transformer having a first coil and a second coil, with each of the first coil and the second coil being magnetically coupled for transmitting power therebetween. The charger circuit also includes a high-voltage power converter connected to the first coil and configured to charge a high-voltage (HV) battery connected thereto. The charger circuit also includes a low-voltage power converter connected to the second coil and configured to charge a low-voltage (LV) battery connected thereto. The charger circuit is operable in a DC-DC conversion mode to transfer power from the HV battery to charge the LV battery. The charger circuit is also operable in a wireless power transfer (WPT) mode to receive power induced in the first coil, from a WPT transceiver, to charge the HV battery.

The present disclosure also provides a charger circuit for a vehicle, comprising: a power factor correction (PFC) stage including an input node, a DC positive conductor, a DC negative conductor, a DC middle conductor, and at least one phase converter configured to receive AC power from the input node and to supply DC power on the DC positive conductor and on the DC middle conductor, with the DC middle conductor having a DC voltage between voltages of the DC positive conductor and the DC negative conductor. The at least one phase converter includes: two high-side power semiconductor devices connected in series between the input node and the DC positive conductor and defining a high-side node therebetween: two low-side power semiconductor devices connected in series between the input node and the DC negative conductor and defining a low-side node therebetween: a first semiconductor device connected between the high-side node and the DC middle conductor for regulating a current flow therebetween; and a second semiconductor device connected between the low-side node and the DC middle conductor for regulating a current flow therebetween.

The present disclosure also provides a method of operating a charger circuit for a vehicle. The method comprises: converting a high voltage (HV) direct current (DC) power from an HV battery to a first alternating current (AC) power by an HV power converter in a DC-DC converter mode: applying the first AC power to a first coil of a transformer to transfer the first AC power to a second coil of the transformer: rectifying the first AC power from the second coil of the transformer to charge a low-voltage (LV) battery in the DC-DC converter mode: applying a second AC power to a transceiver coil to transfer the second AC power to the first coil of the transformer in a wireless power transfer (WPT) mode, with the transceiver coil magnetically coupled to the transformer and separated therefrom by an air gap; and rectifying the second AC power from the first coil of the transformer to charge the HV battery in the WPT mode.

### BRIEF DESCRIPTION OF THE DRAWINGS

Further details, features and advantages of designs of the invention result from the following description of embodiment examples in reference to the associated drawings.

FIG. 1 shows a schematic diagram of a charger circuit configured to supply output power to two different loads from one of two or more different input power sources:

FIG. 2A shows a schematic diagram including part of a charger circuit, in accordance with some embodiments of the present disclosure:

FIG. 2B shows a schematic diagram including other parts of the charger circuit of FIG. 2A, in accordance with some embodiments of the present disclosure:

FIG. 3A shows a schematic diagram of a power factor correction (PFC) stage of a charger circuit operating in a three-phase mode, in accordance with the present disclosure:

FIG. 3B shows a schematic diagram of the power factor correction (PFC) stage of FIG. 3A, operating in a single-phase mode, in accordance with the present disclosure:

FIG. 4 shows a schematic diagram of a power converter circuit, in accordance with the present disclosure:

FIG. 5 shows a cross-sectional diagram of a wireless power transfer (WPT) transformer and a WPT transceiver, in accordance with the present disclosure:

FIG. 6A shows a perspective exploded view of the WPT transformer:

FIG. 6B shows a perspective cutaway view of the WPT transceiver;

FIG. 7A shows a schematic diagram of the power converter circuit of FIG. 4 operating in an onboard charger (OBC) mode, in accordance with the present disclosure:

FIG. 7B shows a schematic diagram of the power converter circuit of FIG. 4 operating in a WPT mode, in accordance with the present disclosure; and

FIG. 7C shows a schematic diagram of the power converter circuit of FIG. 4 operating in a DC-DC converter mode (DC-DC) mode, in accordance with the present disclosure; and

FIG. 8 shows a flow chart listing steps in a method of operating a charger circuit for a vehicle.

### DETAILED DESCRIPTION

Referring to the drawings, the present invention will be described in detail in view of following embodiments.

The present disclosure provides a charger circuit for a vehicle. The charger circuit of the present disclosure may be used an electrified motor vehicle, such as a passenger car or truck, which may be configured as an electric vehicles (EV) and/or a plug-in hybrid electric vehicle (PHEVs). However, the charger circuit of the present disclosure may be utilized with other types of vehicles, such as, for example, automatic guided vehicles (AGVs), delivery bots, airport equipment movers, forklifts, wheelchairs, golf carts, etc..

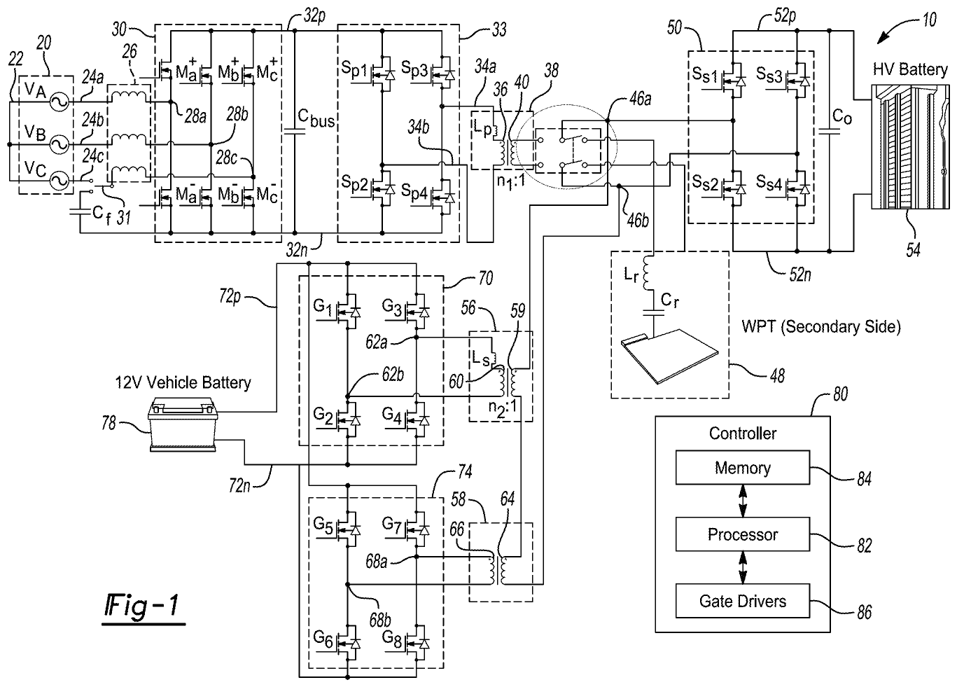

FIG. 1 shows a schematic diagram of a first power converter circuit 10 configured to supply output power to two different loads from one of two or more different input power sources. The first power converter circuit 10 may include conventional designs. The first power converter circuit 10 includes an AC source 20, which may be a 3-phase source having a wye-connected configuration, with each of the three phase voltages being referenced to a common neutral node 22. The AC source 20 supplies AC voltages upon three input conductors 24a, 24b, 24c at 120-degree phase differences. A three-phase inductor 26 includes an inductance connected between each of the input conductors 24a, 24b, 24c and a corresponding one of three intermediate nodes 28a, 28b, 28c, including an A-phase intermediate node 28a, a B-phase intermediate node 28b, and a C-phase intermediate node 28c.

A first power factor correction (PFC) stage 30 includes a set of first field effect transistors (FETs) Mₐ⁺, Mₐ⁻, M_{b}⁺, M_{b}⁻, M_{c}⁺, M_{c}⁻ configured to selectively switch current from corresponding ones of the intermediate nodes 28a, 28b, 28c to supply DC power to a first DC bus 32p, 32n. The first power semiconductor devices Mₐ⁺, Mₐ⁻, M_{b}⁺, M_{b}⁻, M_{c}⁺, M_{c}⁻ include an A-phase positive switch Mₐ⁺ configured to selectively switch current from the A-phase intermediate node 28a to a positive conductor 32p of the first DC bus 32p, 32n, and an A-phase negative switch Mₐ⁻ configured to selectively switch current from a negative conductor 32n of the first DC bus 32p, 32n to the A-phase intermediate node 28a. The first PFC stage 30 includes corresponding ones of the first power semiconductor devices Mₐ⁺, Mₐ⁻, M_{b}⁺, M_{b}⁻, M_{c}⁺, M_{c}⁻ configured to similarly switch current between a corresponding one the B-phase intermediate node 28b or the C-phase intermediate node 28c and the first DC bus 32p, 32n. In some embodiments, the first power semiconductor devices Mₐ⁺, Mₐ⁻, M_{b}⁺, M_{b}⁻, M_{c}⁺, M_{c}⁻ may include field effect transistors (FETs) such as Silicon-based (Si) transistors, Silicon Carbide (SiC) devices, or Gallium Nitride (GaN) transistors. In some embodiments, the first power semiconductor devices Mₐ⁺, Mₐ⁻, M_{b}⁺, M_{b}⁻, M_{c}⁺, M_{c}⁻ may be rated for at least 650V. However, devices with other voltage ratings may be used. The first power semiconductor devices may alternatively use another type of FET or another type of device, such as a junction transistor. A bus capacitor C_{bus} is connected across the first DC bus 32p, 32n for smoothing the DC voltage thereupon.

In some embodiments, and as shown in FIG. 1, a first switch 31 may have a first position, selectively coupling the C-phase node 28c to a C-phase input conductor 24c via a C-phase inductance of the three-phase inductor 26 for receiving 3-phase power from the AC source 20. The first switch 31 may alternatively be placed in a second position, with the C-phase node 28c disconnected from the C-phase input conductor 24c, and with the C-phase node 28c connected to a series combination of the C-phase inductance of the three-phase inductor 26 and a filter capacitor C_{ƒ}, which has a terminal connected to the negative conductor 32n of the first DC bus 32p, 32n.

The first power converter circuit 10 includes a dual-active bridge (DAB) including a first inverter stage 33, a first transformer 38, and a first HV power converter 50. The first inverter stage 33 includes a set of second power semiconductor devices Sₚ₁, Sₚ₂, Sₚ₃, Sₚ₄ configured to generate a high-frequency alternating current power upon a first set of AC conductors 34a, 34b. The second power semiconductor devices Sₚ₁, Sₚ₂, Sₚ₃, Spa of the first inverter stage 33 may include field effect transistors (FETs), such as GaN transistors, although other types of devices may be used. In some embodiments, the second power semiconductor devices Sₚ₁, Sₚ₂, Sₚ₃, Sₚ₄ may have a voltage rating of at least 650V. However, devices with other voltage ratings may be used. A primary coil 36 of the first transformer 38 is connected across the first AC conductors 34a, 34b. The primary coil 36 is shown as a transformer coil in series with a primary inductance Lₚ, which represents an inductive effect of the primary coil 36 and not a separate physical device.

A secondary coil 40 of the first transformer 38 is connected to a second set of AC conductors 46a, 46b, which are energized with a high-frequency AC power that may have a same voltage, a higher voltage, or a lower voltage than the AC voltage across the first AC conductors 34a, 34b, depending on a winding ratio between the primary coil 36 and the secondary coil 40 of the first transformer 38.

The first HV power converter 50 of the first power converter circuit 10 includes a set of third FETs Sₛ₁, Sₛ₂, Sₛ₃, Sₛ₄ operable as a synchronous rectifier to convert the high-frequency AC power from the second set of AC conductors 46a, 46b to a DC power upon a set of high-voltage (HV) DC output terminals 52p, 52n. The third FETs Sₛ₁, Sₛ₂, Sₛ₃, Sₛ₄ of the first HV power converter 50 may be 650V-rated GaN transistors, although other types of devices may be used. A first output capacitor Co is connected across the HV DC output terminals 52p, 52n for reducing ripple in the DC voltage thereacross. The HV DC output terminals 52p, 52n are coupled to a HV battery 54 that may provide power for driving one or more traction motors to propel a vehicle. The HV DC output terminals 52p, 52n may be energized with a charging voltage for charging the HV battery 54, which may have a nominal voltage of 400 VDC or 800 VDC. However, the HV battery 54 may have a different nominal voltage. In some embodiments, the HV battery 54 may have a nominal voltage of 48 VDC or 12 VDC.

A second switch 44, which is a dual-pole, dual-throw (DPDT) switch selectively couples the secondary coil 40 of the first transformer 38 to the first HV power converter 50 in a first position, to provide for onboard charging (OBC) functionality. In a second position, the second set of AC conductors 46a, 46b, and the first HV power converter 50 connected thereto, are disconnected from the secondary coil 40 of the first transformer 38 and are, instead, connected to a wireless power transfer (WPT) secondary device 48, which may include a resonant inductance Lᵣ in series with a resonant capacitor Cᵣ configured to receive power from a separate WPT transceiver (not shown in FIG. 1), and which may be located in a stationary position. For example, the WPT transceiver may be located on or within the ground. The second switch 44, thus, enables the first power converter circuit 10 to operate in either of a WPT or OBC mode. Phase-shift control can be adopted to adjust the output power for HV and LV output separately. However, it can be costly to implement such a double-throw switch for the second switch 44.

The first power converter circuit 10 also includes a second transformer 56 and a third transformer 58. The second transformer 56 has a primary winding 59 and a secondary winding 60, and the third transformer 58 has a primary winding 64 and a secondary winding 66. The primary windings 59, 64 of the second and third transformers 56, 58, respectively, are connected in series between the second set of AC conductors 46a, 46b. The secondary winding 60 of the second transformer 56 is connected to a third set of AC conductors 62a, 62b, and the secondary winding 66 of the third transformer 58 is connected to a fourth set of AC conductors 68a, 68b. In some embodiments, the second and third transformers 56, 58 may be combined in to a single physical device with multiple windings or multiple taps of a larger winding.

A first low-voltage (LV) rectifier 70 of the first power converter circuit 10 includes a set of fourth FETs G₁, G₂, G₃, G₄ configured as a synchronous rectifier to convert AC power from the third set of AC conductors 62a, 62b to a low-voltage (LV) DC power upon a set of first LV output terminals 72p, 72n. The fourth FETs G₁, G₂, G₃, G₄ of the first LV rectifier 70 may be 100V-rated GaN transistors, although other types of devices may be used.

A second low-voltage (LV) rectifier 74 of the first power converter circuit 10 includes a set of fifth FETs G₅, G₆, G₇, G₈ configured as a synchronous rectifier to convert AC power from the fourth set of AC conductors 68a, 68b to a low-voltage (LV) DC power upon the first LV output terminals 72p, 72n. The fifth FETs G₅, G₆, G₇, G₈ of the second LV rectifier 74 may be 100V-rated GaN transistors, although other types of devices may be used.

The first LV rectifier 70 and the second LV rectifier 74 may, therefore, operate in parallel to provide more current than either of the first LV rectifier 70 or the second LV rectifier 74 operating alone. In some embodiments, one or both of the first LV rectifier 70 and the second LV rectifier 74 may be switched on or off, depending on the current load requirements on the first LV output terminals 72p, 72n at any given time.

The first LV output terminals 72p, 72n are coupled to a LV battery 78 that may provide accessory power for operating low-voltage systems and devices in the vehicle. The first LV output terminals 72p, 72n may be energized with a charging voltage for charging LV battery 78, which may have a nominal voltage of 12 VDC. However, the LV battery 78 may have a different nominal voltage, such as 36 VDC or 48 VDC.

Each of the first HV power converter 50, and the LV rectifiers 70, 74 may have an H-Bridge configuration and may operate together for DC/DC conversion, with the first HV power converter 50 operating in an inverter mode to generate AC power upon the second set of AC conductors 46a, 46b, and the LV rectifiers 70, 74 generating LV DC power upon the first LV output terminals 72p, 72n. In case higher power for DC/DC conversion is required, additional H-bridge modules can be added. However, due to requirements of isolation between the HV battery 54 and LV battery 78, a high turn ratio and high current transformer (such as the second and third transformers 56, 58) must be equipped to satisfy the standards, which adds on the cost and volume. Meanwhile, such approach still exhibits redundancy.

A controller 80 includes a processor 82 coupled to a memory 84. The controller 80 also includes a set of gate drivers 86 coupled to the processor 82 and having circuitry configured to operate some or all of the FETs of the first PFC stage 30, the first inverter stage 33, the first HV power converter 50, and the first and second LV rectifiers 70, 74. The processor 82 may include any suitable processor, such as a microprocessor, microcontroller, application-specific integrated circuit (ASIC), field-programmable gate array (FPGA), etc. Additionally. or alternatively, the controller 80 may include any suitable number of processors, in addition to or other than the processor 82. The memory 84 may comprise a single disk or a plurality of disks (e.g., hard drives), and includes a storage management module that manages one or more partitions within the memory 84. In some embodiments, memory 84 may include flash memory, semiconductor (solid state) memory or the like. The memory 84 may include Random Access Memory (RAM), a Read-Only Memory (ROM), or a combination thereof. The memory 84 may include instructions that, when executed by the processor 82, cause the processor 82 to, at least, control various functions of the first power converter circuit 10.

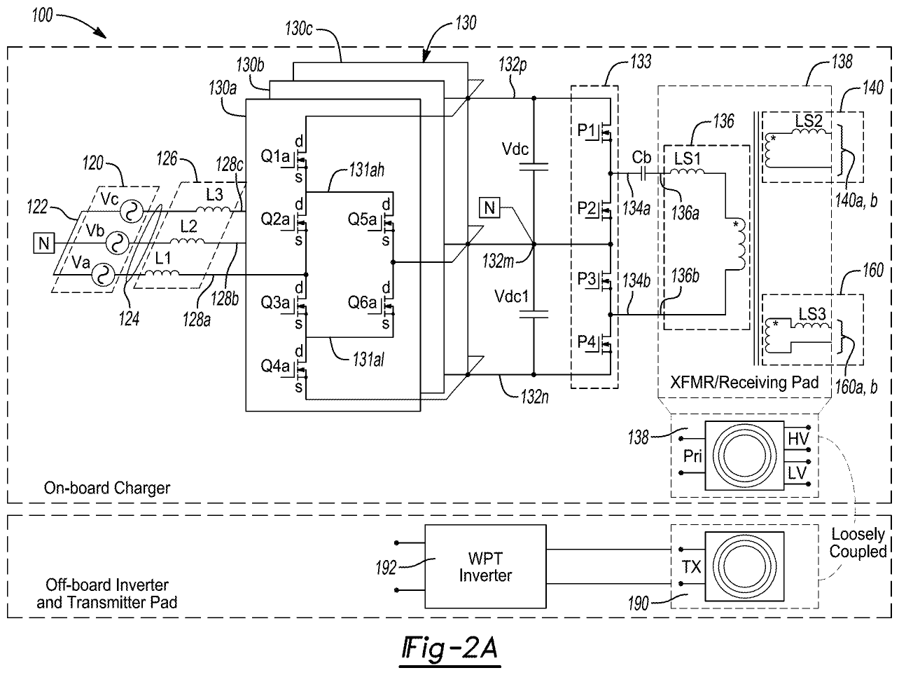

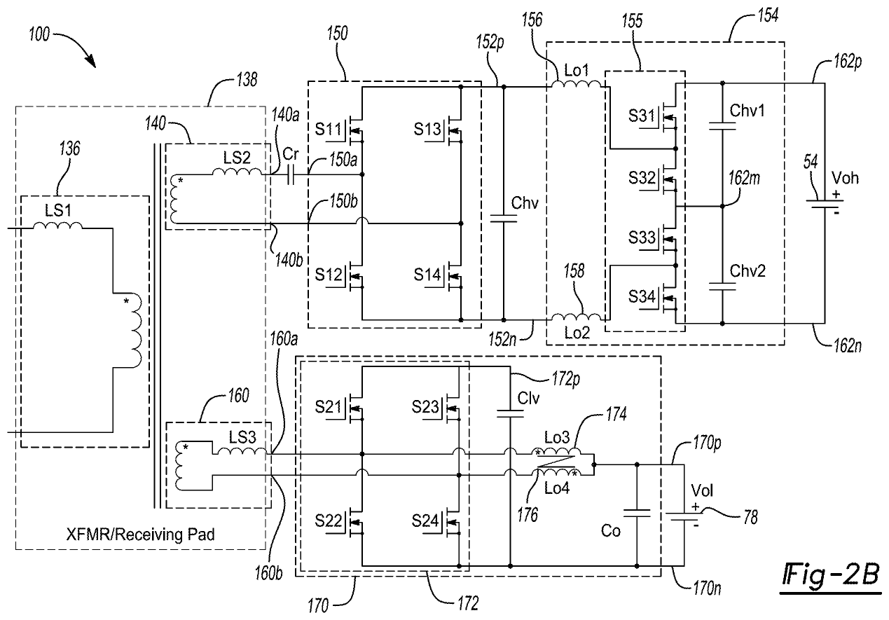

FIG. 2A shows a schematic diagram including part of a second power converter circuit 100, in accordance with some embodiments of the present disclosure. The second power converter circuit 100 may include and be controlled by a controller that may be similar to the controller 80 described with reference to FIG. 1, but with gate drivers and instructions matching the hardware configuration of the second power converter circuit 100.

The second power converter circuit 100 may be configured to accommodate a single-phase input power at 220 VAC and/or a three-phase input power at 208˜480V AC, and the HV battery of 200˜800V. The second power converter circuit 100 may be configured to operate in each of an integrated onboard charger (OBC) mode, a wireless power transfer (WPT) mode, and an auxiliary power module (APM) mode, which may also be called a DC-DC mode. The second power converter circuit 100 may be compatible with 800V or 400V propulsion/battery system. The second power converter circuit 100 may be capable of charging both a high-voltage (HV) battery and a low-voltage (LV) battery simultaneously. The second power converter circuit 100 may also include an integrated magnetic device capable of functioning as both a galvanic transformer and a wireless power transfer (WPT) receiving pad.

The second power converter circuit 100 includes a 3-phase alternating current (AC) source 120, which may have a wye-connected configuration, with each of the three phase voltages being referenced to a common neutral node 122. The 3-phase AC source 120 supplies AC voltages upon three input conductors 124. A three-phase inductor 126 includes an inductance connected between each of the input conductors 124 and a corresponding one of three intermediate nodes 128a, 128b, 128c, including an A-phase intermediate node 128a, a B-phase intermediate node 128b, and a C-phase intermediate node 128c. The 3-phase AC source 120 and the three-phase inductor 126 may be similar or identical to corresponding components in the first power converter circuit 10 of FIG. 1.

A second power factor correction (PFC) stage 130 includes A. B. and C phase PFC converters 130a, 130b, 130c, which may each be similar or identical. The second PFC stage 130 may provide an input (i.e. grid-side) power factor from −1 to +1. With the second power converter circuit 100 operating in an onboard charger (OBC) mode, the second PFC stage 130 may have a power factor equal to, or approximately equal to, 1.0, meaning it may appear to the 3-phase AC source 120 (e.g. a power grid source) as a resistive load. Only the A-phase PFC converter 130a is shown, for the sake of simplicity. Each of the PFC converters 130a, 130b, 130c supplies DC power from a corresponding one of the intermediate nodes 128a, 128b, 128c to a second DC bus 132p, 132n, 132m having DC positive and negative conductors 132p, 132n, and a DC middle conductor 132m with a DC potential between the DC potentials of the DC positive and negative conductors 132p, 132n. A first DC bus capacitor Vdc is connected between the DC positive conductor 132p and the DC middle conductor 132m, and a second DC bus capacitor Vdc is connected between the DC middle conductor 132m and the DC negative conductor 132n. The DC positive conductor 132p may have a DC voltage twice that of the DC middle conductor 132m, with each referenced from the DC negative conductor 132n. The DC middle conductor 132m may be connected to the common neutral node 122 of the 3-phase AC source 120.

The A-phase PFC converter 130a includes a set of sixth field effect transistors (FETs) Q1a, Q2a, Q3a, Q4a, Q5a, Q6a configured to selectively switch current from the A-phase intermediate node 128a to supply the DC power on the second DC bus 132p, 132n, 132m, In some embodiments, the sixth FETs Q1a, Q2a, Q3a, Q4a, Q5a, Q6a may include field effect transistors. The sixth FETs Q1a, Q2a, Q3a, Q4a, Q5a, Q6a may include Silicon-based (Si) transistors, such as Silicon Carbide (SiC) devices or Gallium Nitride (GaN) transistors, which may be rated for 650V. The sixth FETs may alternatively use another type of FET or another type of device, such as a junction transistor. The A-phase PFC converter 130a includes two FETs Q1a, Q2a connected in series to selectively switch current between the A-phase intermediate node 128a and the DC positive conductor 132p, The sixth FETs Q1a, Q2a, Q3a, Q4a, Q5a, Q6a include a first PFC FET Q1a having a drain terminal connected to the DC positive conductor 132p, and a source terminal connected to an A-phase high-side node 131ah. The sixth FETs Q1a, Q2a, Q3a, Q4a, Q5a, Q6a also include a second PFC FET Q2a having a drain terminal connected to the A-phase high-side node 131ah, and a source terminal connected to the A-phase intermediate node 128a. The sixth FETs Q1a, Q2a, Q3a, Q4a, Q5a, Q6a include a third PFC FET Q3a having a drain terminal connected to the A-phase intermediate node 128a, and a source terminal connected to an A-phase low-side node 131al. The sixth FETs Q1a, Q2a, Q3a, Q4a, Q5a, Q6a also include a fourth PFC FET Q4a having a drain terminal connected to the A-phase low-side node 131al, and a source terminal connected to the DC negative conductor 132n. The sixth FETs Q1a, Q2a, Q3a, Q4a, Q5a, Q6a also include a fifth PFC FET Q5a having a drain terminal connected to the A-phase high-side node 131ah, and a source terminal connected to the DC middle conductor 132m, The sixth FETs Q1a, Q2a, Q3a, Q4a, Q5a, Q6a include a sixth PFC FET Q6a having a drain terminal connected to the DC middle conductor 132m, and a source terminal connected to an A-phase low-side node 131al.

The second power converter circuit 100 includes a dual-active bridge (DAB) comprising a second inverter stage 133, a WPT transformer 138, and a second HV power converter 150. The second inverter stage 133 includes a set of seventh FETs P₁, P₂, P₃, P₄ configured to generate a high-frequency alternating current power upon a third set of AC conductors 134a, 134b. The seventh FETs P₁, P₂, P₃, P₄ of the second inverter stage second 133 may be 650V-rated GaN transistors, although other types of devices may be used.

The WPT transformer 138 includes three coils each being magnetically coupled and configured to function as both a traditional transformer and as a receiver coil for wireless power transfer (WPT). The WPT transformer 138 includes an onboard charging (OBC) coil 136 having two terminals 136a, 136b. One of the terminals 136a is connected to one AC conductor 134a of the third set of AC conductors 134a, 134b, with a DC blocking capacitor Cb connected therebetween for blocking DC power from being supplied to the OBC coil 136. The other one of the terminals 136b of the OBC coil 136 is connected directly to the other AC conductor 134b of the third set of AC conductors 134a, 134b. The OBC coil 136 is shown as a transformer coil in series with an inductance LS1, which represents an inductive effect of the OBC coil 136 and not a separate physical device. The WPT transformer 138 also includes a first coil 140 having two terminals 140a, 140b, and a second coil 160 having two terminals 160a, 160b. Like the OBC coil 136, each of the first coil 140 and the second coil 160 is shown as a transformer coil in series with an inductance LS2, LS3, which represents an inductive effect of the corresponding coil 140, 160 and not a separate physical device. With the second power converter circuit 100 operating in the OBC mode, the OBC coil 136 may function as a primary winding (Pri), the first coil 140 may function as a high-voltage (HV) secondary winding, and the second coil 160 may function as a low-voltage (LV) secondary winding.

FIG. 2A also shows a diagram illustrating the WPT transformer 138 configured for wireless power transfer. Specifically, a WPT transceiver 190 is aligned with the WPT transformer 138 and loosely magnetically coupled thereto for wirelessly transferring power from the WPT transceiver 190 to the WPT transformer 138. The WPT transceiver 190 may be spaced apart from the WPT transformer 138 by an air gap and/or one or more insulating materials. The WPT inverter 192 is coupled to the WPT transceiver 190 to provide power thereto. The WPT transceiver 190 and the WPT inverter 192 may be provided as a stationary unit coupled to a grid (or utility) source of electrical power.

FIG. 2B shows a schematic diagram including other parts of the second power converter circuit 100 of FIG. 2A. FIG. 2B shows the WPT transformer 138, including details of circuits connected to the first coil 140 and the second coil 160. FIG. 2B includes details of the second HV power converter 150 connected to the first coil 140, and an LV power converter 170 connected to the second coil 160.

The second HV power converter 150 of the second power converter circuit 100 includes a first input conductor 150a connected to a first terminal 140a of the first coil 140 of the WPT transformer 138 with a compensation capacitor Cr connected therebetween to compensate for leakage inductance, thereby improving the effectiveness of the power delivery. The second HV power converter 150 also includes a second input conductor 150b connected directly to a second terminal 140b of the first coil 140. The second HV power converter 150 also includes a set of eighth FETs S₁₁, S₁₂, S₁₃, S₁₄ operable as a synchronous rectifier to convert the high-frequency AC power from the first coil 140 to a DC power upon a set of DC intermediate conductors 152p, 152n. The eighth FETs S₁₁, S₁₂, S₁₃, S₁₄ of the second HV power converter 150 may be 650V-rated GaN transistors, although other types of devices may be used. A high-voltage filter capacitor Cₕᵥ is connected across the DC intermediate conductors 152p, 152n for reducing ripple in the DC voltage thereacross.

The second power converter circuit 100 includes a buck/boost converter 154 for increasing or reducing voltage to or from an HV battery 54 connected thereto. The buck/boost converter 154 may also be called an HV power converter. The buck/boost converter 154 includes a first output inductor 156 having a first terminal connected to a positive node 152p of the DC intermediate conductors 152p, 152n, and a second output inductor 158 having a first terminal connected to the negative node 152n of the DC intermediate conductors 152p, 152n. The buck/boost converter 154 includes an HV positive output terminal 162p, an HV negative output terminal 162n, and an HV middle output terminal 162m. A first HV output capacitor Chv1 is connected between the HV positive output terminal 162p and the HV middle output terminal 162m, and a second HV output capacitor Chv2 is connected between the HV middle output terminal 162m and the HV negative output terminal 162n. The HV positive output terminal 162p may have a DC voltage twice that of the HV middle output terminal 162m, with each referenced from the HV negative output terminal 162n.

The buck/boost converter 154 also includes a step up/down converter 155 having a set of ninth FETs S₃₁, S₃₂, S₃₃, S₃₄. The ninth FETs S₃₁, S₃₂, S₃₃, S₃₄ include a first FET S₃₁ configured to selectively control current flow between a second terminal of the first output inductor 156 and the HV positive output terminal 162p. The ninth FETs S₃₁, S₃₂, S₃₃, S₃₄ also include a second FET S₃₂ configured to selectively control current flow between the second terminal of the first output inductor 156 and the HV middle output terminal 162m. The ninth FETs S₃₁, S₃₂, S₃₃, S₃₄ also include a third FET S₃₃ configured to selectively control current flow between a second terminal of the second output inductor 158 and the HV middle output terminal 162m. The ninth FETs S₃₁, S₃₂, S₃₃, S₃₄ include a fourth FET S₃₄ configured to selectively control current flow between the second terminal of the second output inductor 158 and the HV negative output terminal 162n. The first output inductor 156 and the second output inductor 158 may be magnetically coupled (i.e. wound around a shared core), with opposite polarities.

The second power converter circuit 100 also includes an LV power converter 170 for providing LV power with a regulated LV voltage upon a set of second LV output terminals 170p, 170n, which may be used for charging an LV battery 78 connected thereacross. The second LV output terminals 170p, 170n may be energized with a charging voltage for charging LV battery 78, which may have a nominal voltage of 12 VDC. However, the LV battery 78 may have a different nominal voltage, such as 36 VDC or 48 VDC. The LV power converter 170 includes an H-bridge circuit 172 having a set of tenth FETs S₂₁, S₂₂, S₂₃, S₂₄ connected to the second coil 160 of the WPT transformer 138 and operated to produce a DC voltage between an LV intermediate node 172p and a negative terminal 170n of the second LV output terminals 170p, 170n. An LV capacitor Clv is connected between the LV intermediate node 172p and a negative terminal 170n for storing charge from the H-bridge circuit 172. The LV power converter 170 also includes a third output inductor 174 connected between a first terminal 160a of the second coil 160 of the WPT transformer 138 and a positive terminal 170p of the second LV output terminals 170p, 170n. The LV power converter 170 also includes a fourth output inductor 176 connected between a second terminal 160b of the second coil 160 of the WPT transformer 138 and the negative terminal 170n of the second LV output terminals 170p, 170n. The third output inductor 174 and the fourth output inductor 176 may be magnetically coupled (i.e. wound around a shared core), with opposite polarities. The LV power converter 170 may be operated as a typical current-fed H-bridge. Many different control strategies may be used for operating the LV power converter 170. In one control strategy, a duty cycle of the bottom switches S₂₂ and S₂₄ is controlled to boost the voltage across the LV capacitor Clv, making this voltage match a voltage across the high-voltage filter capacitor Chv. For example, a voltage of the LV intermediate node 172p (referenced to negative terminal 170n) may be equal to a voltage across the DC intermediate conductors 152p, 152n times a ratio of turns of the first coil 140 and the second coil 160 of the WPT transformer 138. A phase shift between one or more of the eighth FETs S₁₁, S₁₂, S₁₃, S₁₄ of the second HV power converter 150 (e.g. upper switch S₁₁) and one or both of the upper switches S₂₁, S₂₃ of the H-bridge circuit 172 can be controlled to adjust a power flow from the second HV power converter 150 to the LV power converter 170.

The HV DC output terminals 158p, 158n are coupled to an HV battery 54 that may provide power for driving one or more traction motors to propel a vehicle. The HV DC output terminals 158p, 158n may be energized with a charging voltage for charging the HV battery 54, which may have a nominal voltage of 400 VDC or 800 VDC. However, the HV battery 54 may have a different nominal voltage.

Each of the second HV power converter 150, and the LV power converter 170 may have an H-Bridge configuration and may operate together for DC/DC conversion, with the second HV power converter 150 operating in an inverter mode to generate AC power upon the input conductors 150a, 150b, and the LV power converter 170 regulating LV DC power upon the second LV output terminals 170p, 170n.

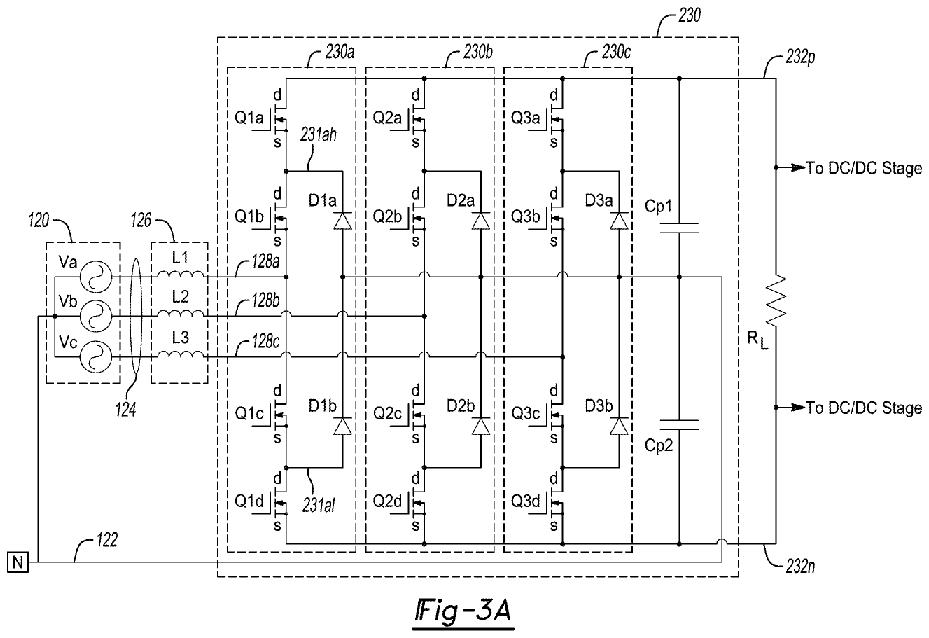

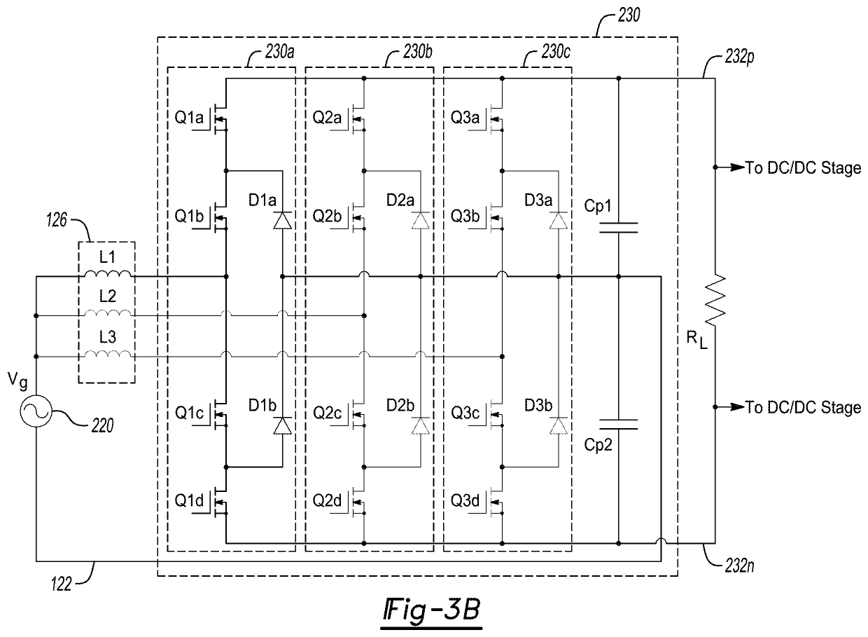

FIG. 3A shows a schematic diagram of a third power factor correction (PFC) stage 230 operating in a three-phase mode. The third PFC stage 230 may be powered by the 3-phase AC source 120 coupled to the three-phase inductor 126, which together supply power to the A-phase intermediate node 128a, the B-phase intermediate node 128b, and the C-phase intermediate node 128c, which are each referenced to the common neutral node 122. This configuration may be similar or identical to corresponding components of the second power converter circuit 100 of FIGS. 2A-2B. The third PFC stage 230 may have a high power factor, meaning it may appear as, or similarly to, a resistive load. For example, the third PFC stage 230 may be controlled to have a power factor with any value between −1.0 and +1.0

The third PFC stage 230 includes A. B. and C phase PFC converters 230a, 230b, 230c, which may each be similar or identical. Only the A-phase PFC converter 230a described, for the sake of simplicity. Each of the PFC converters 230a, 230b, 230c supplies DC power from a corresponding one of the intermediate nodes 128a, 128b, 128c to a third DC bus 232p. 232n having a DC positive conductor 232p, and a DC negative conductor 232n.

The third PFC converter 230 includes a set of eleventh field effect transistors (FETs) Q1a, Q1b, Q1c, Q1d, configured to selectively switch current from the A-phase intermediate node 128a to generate the DC power on the third DC bus 232p, 232n, 132m, In some embodiments, the eleventh FETs Q1a, Q1b, Q1c, Q1d may include field effect transistors. The eleventh FETs Q1a, Q1b, Q1c, Q1d may include Silicon-based (Si) transistors, such as Silicon Carbide (SiC) devices or Gallium Nitride (GaN) transistors, which may be rated for 650V. The eleventh FETs may alternatively use another type of FET or another type of device, such as a junction transistor. The A-phase PFC converter 230a includes two FETs Q1a, Q1b connected in series to selectively switch current between the A-phase intermediate node 128a and the DC positive conductor 132p, The eleventh FETs Q1a, Q1b, Q1c, Q1d include a first A-phase FET Q1a having a drain terminal connected to the DC positive conductor 232p, and a source terminal connected to an A-phase high-side node 231ah. The eleventh FETs Q1a, Q1b, Q1c, Q1d also include a second A-phase FET Q1b having a drain terminal connected to the A-phase high-side node 231ah, and a source terminal connected to the A-phase intermediate node 128a. The eleventh FETs Q1a, Q1b, Q1c, Q1d also include a third A-phase FET Q1c having a drain terminal connected to the A-phase intermediate node 128a, and a source terminal connected to an A-phase low-side node 231al. The eleventh FETs Q1a, Q1b, Q1c, Q1d also include a fourth A-phase FET Q1d having a drain terminal connected to the A-phase low-side node 231al, and a source terminal connected to the DC negative conductor 232n.

The third PFC converter 230 also includes an A-phase high-side diode D1a having a cathode terminal connected to the A-phase high-side node 231ah and having an anode terminal connected to the common neutral node 122. The A-phase high-side diode D1a may conduct current from the common neutral node 122 to the A-phase high-side node 231ah while blocking current flow in an opposite direction. The third PFC converter 230 also includes an A-phase low-side diode D1b having a cathode terminal connected to the common neutral node 122 and having an anode terminal connected to the A-phase low-side node 231al. The A-phase low-side diode D1b may conduct current from the A-phase low-side node 231al to the common neutral node 122 to the while blocking current flow in an opposite direction.

The third PFC converter 230 also includes a high-side output capacitor Cp1 connected between the DC positive conductor 232p and the common neutral node 122. The third PFC converter 230 also includes a low-side output capacitor Cp2 connected between the common neutral node 122 and the DC negative conductor 232n. A load resistance R_{L} is connected between the DC positive conductor 232p and the DC negative conductor 232n. The load resistance R_{L} may represent a load presented on the output due to connection of subsequent circuitry, such as a DC/DC stage. Alternatively or additionally, a physical load resistance load resistance R_{L} may be connected between the DC positive conductor 232p and the DC negative conductor 232n. The physical load resistance R_{L} may be used to bleed-off a residual charge on the output capacitors Cp1, Cp2 when the third PFC converter 230 is de-energized.

FIG. 3B shows a schematic diagram of the third PFC converter 230, operating in a single-phase mode. In the single-phase mode, the 3-phase AC source 120 is replaced by a single-phase AC source 220, which is connected to a first inductor L1 of the three-phase inductor 126, and to the common neutral node 122. In the single-phase mode, only the A-phase PFC converter 230a is active, and the B-phase and C-phase converters 230b. 230c are idle. The single-phase mode could use any one of the phase converters 230a, 230b, 230c of the third PFC converter 230.

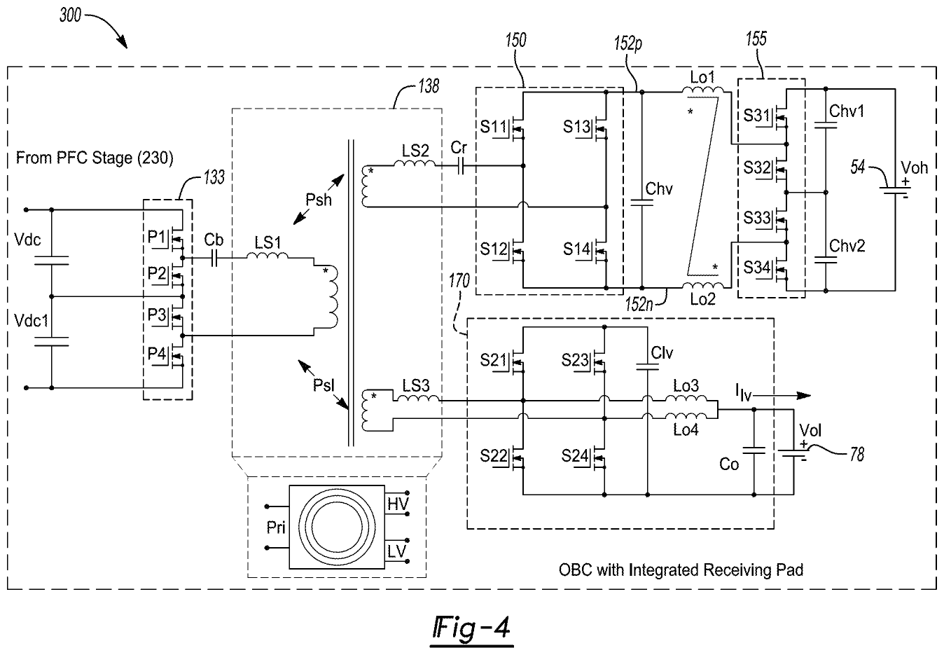

FIG. 4 shows a schematic diagram of a third power converter circuit 300 having a WPT transformer 138. The third power converter circuit 300 may be similar or identical to the first power converter circuit 100 of FIGS. 2A-2B, but without the second PFC stage 130. Instead, the third power converter circuit 300 may receive DC power from the third PFC converter 230, which may operate in a three-phase mode or a single-phase mode.

The third power converter circuit 300 may include 650V GaN switches instead of expensive 1200V SiC devices, and drastically reduces the number of transformers between the HV side and LV side (i.e. the three transformers 38, 56, 58 of the first power converter 10 are consolidated into a single device, namely the WPT transformer 138). Two receiving coils for HV (i.e. the first coil 140) and LV (i.e. the second coil 160) are integrated on a same frame. Due to the close distance between the coils 140, 160, a relatively high coupling coefficient can be obtained. i.e., K>0.8. Given such a high coupling coefficient, the two coils 140, 160 can act as a transformer for isolation and voltage-matching purposes. Compensation networks may be required for each port to minimize the reactive power. The primary coil 136 is also integrated, realizing higher coupling coefficient, which in return reduces the reactive power.

The power converter circuits of the present disclosure 100, 200, 300 may allow for bidirectional energy flow, meaning power can flow in either of two opposite directions between one or more batteries 54, 78 and a utility grid, e.g via the 3-phase AC source 120. In some embodiments, the power converter circuits of the present disclosure 100, 200, 300 may be operated to deliver AC power to one or more AC loads, such as power tools, lighting, etc. In some embodiments, the power converter circuits of the present disclosure 100, 200, 300 may allow for power conversion between two or more of a high-voltage (HV) device, a low-voltage (LV) device, the AC utility grid, and/or one or more AC loads. For example, the second PFC stage 130 and/or the third PFC stage 230 may operate in conjunction with the second inverter stage 133 to supply AC power for operating an external AC load, such as AC tools at a jobsite. In this way, a vehicle equipped with a power converter circuit of the present disclosure 100, 200, 300 may function as a source of AC power, taking the place of a conventional AC generator.

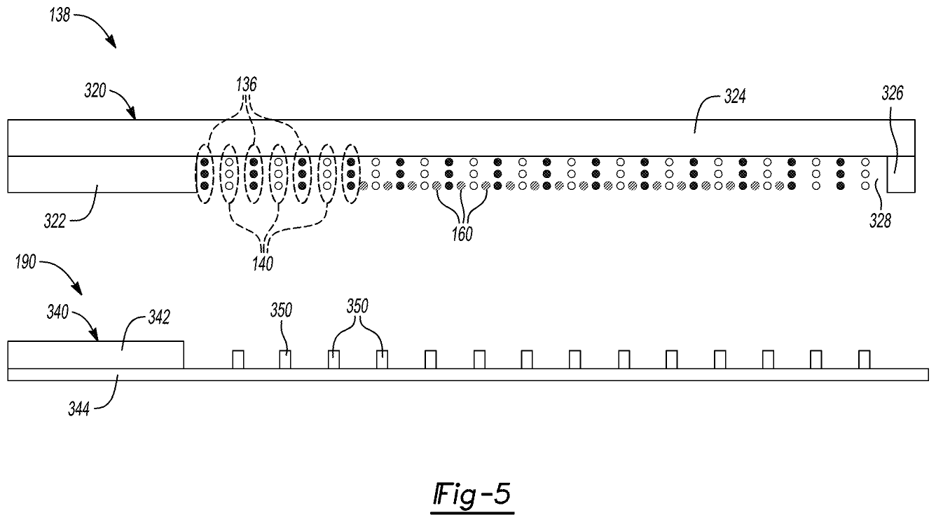

FIG. 5 shows a cross-sectional diagram of the WPT transformer 138 and the WPT transceiver 190 extending parallel thereto for providing wireless power transfer therebetween. The WPT transformer 138 includes a first core 320 having a first spool 322 with a cylindrical shape, and a first backing plate 324 having a generally flat, circular shape adjacent to and coaxial with the first spool 322. The first core 320 also includes a peripheral rim 326 extending around an outer peripheral edge of the first backing plate 324 and extending axially from a same side thereof as the first spool 322. The first spool 322, the first backing plate 324, and the peripheral rim 326 together define an annular cavity 328 having a rectangular cross-section for receiving the OBC coil 136, the first coil 140, and the second coil 160. The first core 320 may be made of material having low reluctance, such as iron or steel. The WPT transformer 138 includes the OBC coil 136, which may also be called a primary coil, and the first coil 140, which may be called an HV coil, wound around the first spool 322 and within the annular cavity 328. The OBC coil 136 and the first coil 140 may be wound in an alternating or interleaved fashion, as shown in FIG. 5. The WPT transformer 138 also includes the second coil 160, which may be called an LV coil, wound around the central spool 322 and within the annular cavity 328. The second coil 136 may be interleaved with at least a part of the OBC coil 136 and the first coil 140.

FIG. 5 also shows details of the WPT transceiver 190. The WPT transceiver 190 includes a second core 340 having a second spool 342 with a cylindrical shape, and a second backing plate 344 having a generally flat, circular shape adjacent to and coaxial with the second spool 342. The second core 340 may be made of material having low reluctance, such as iron or steel. The WPT transceiver 190 also includes a transceiver coil 350 wound around the second the second spool 342 and adjacent to the second backing plate 344. The WPT transceiver 190 may be configured to induce a magnetic field and to wirelessly transmit power to one or more of the OBC coil 136, the first coil 140, and/or the second coil 160 of the WPT transformer 138.

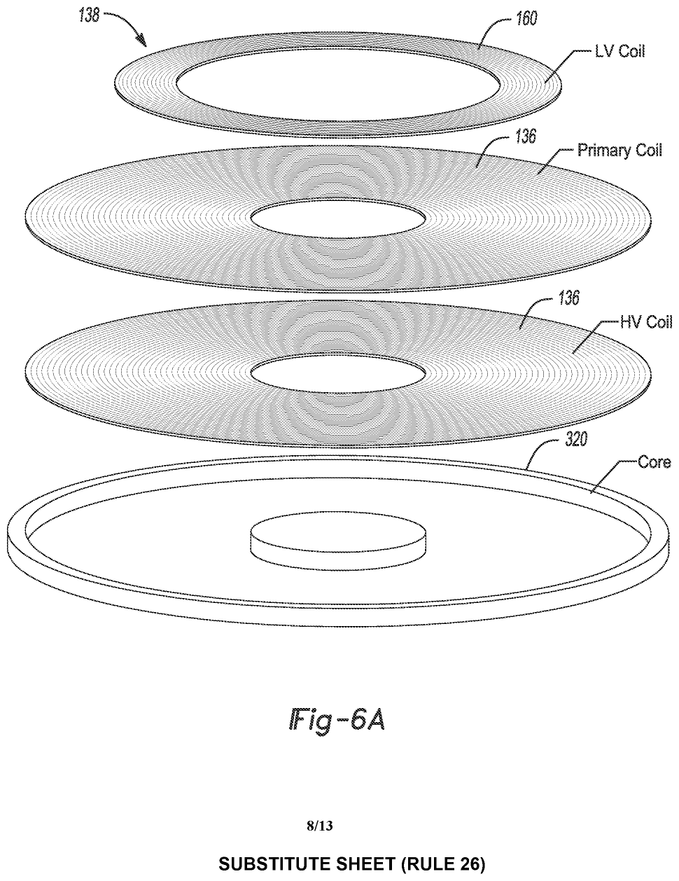

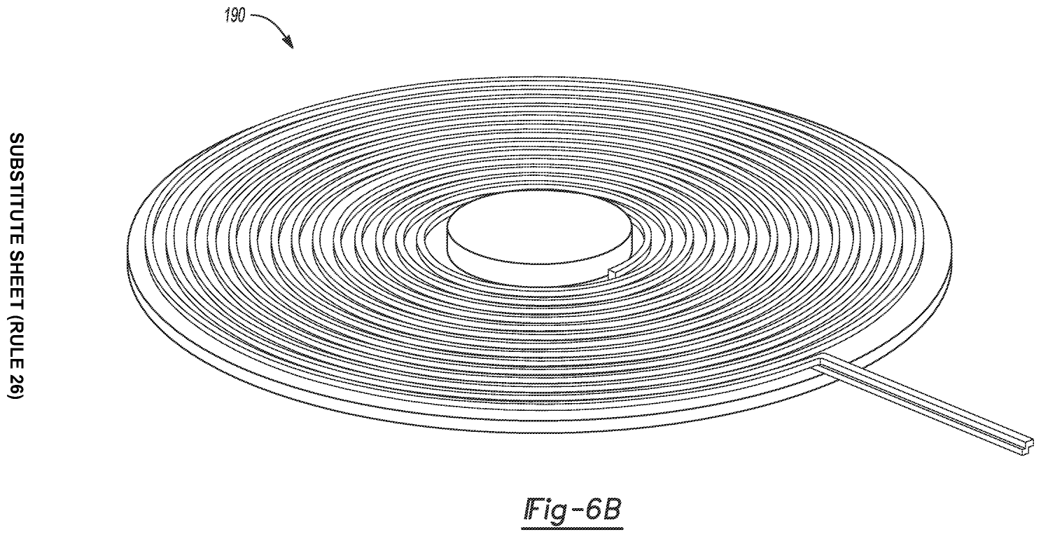

FIG. 6A shows a perspective exploded view of the WPT transformer 138, and FIG. 6B shows a perspective cutaway view of the WPT transceiver 190. Either or both of WPT transformer 138 and/or the WPT transceiver 190 may include other components, such as a potting material and/or an enclosure for preventing moisture or other contaminants from damaging or otherwise interfering with operation of the coils 136, 140, 160, 350.

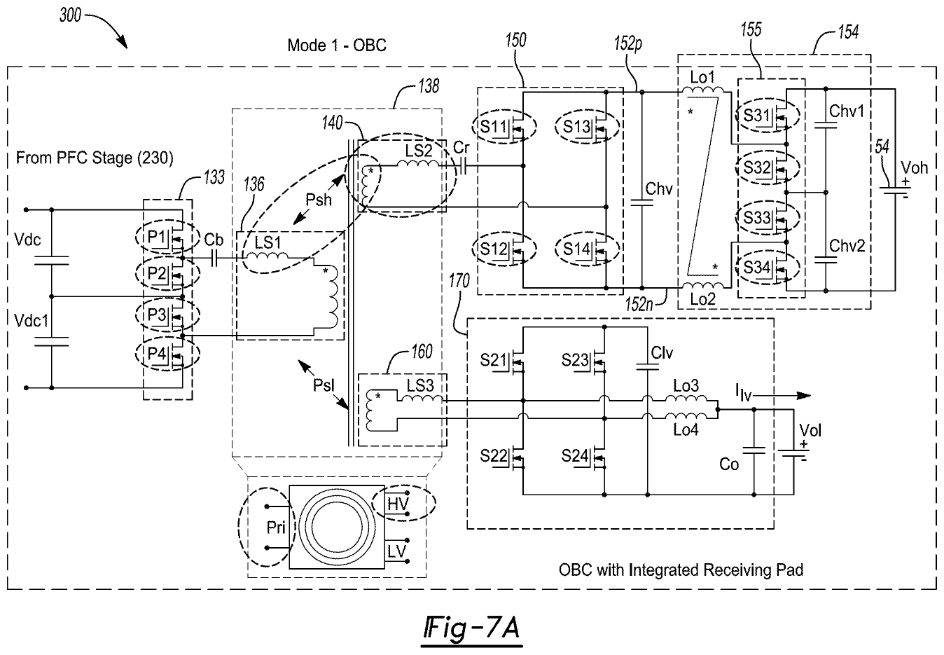

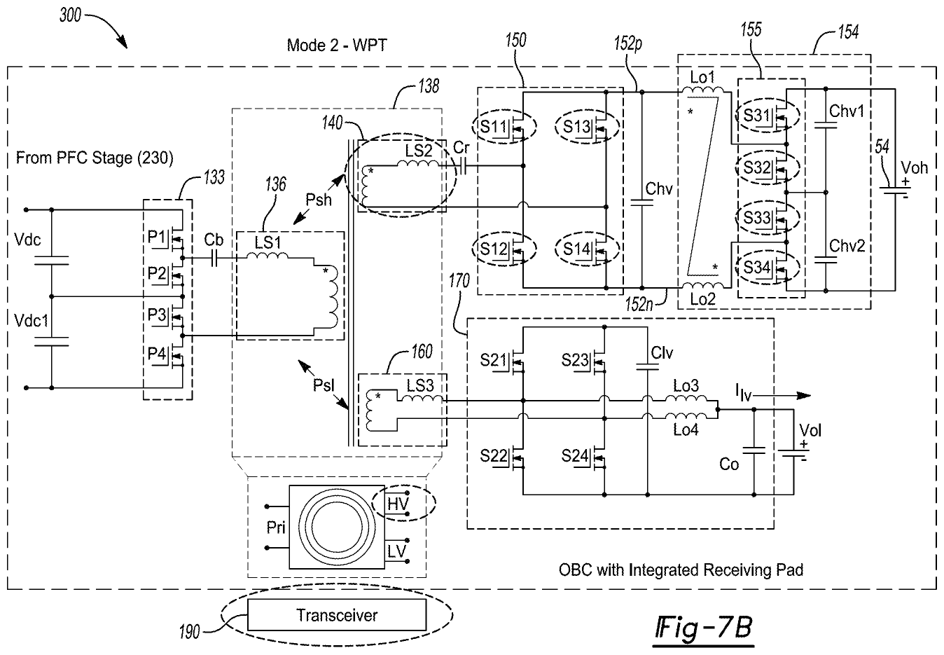

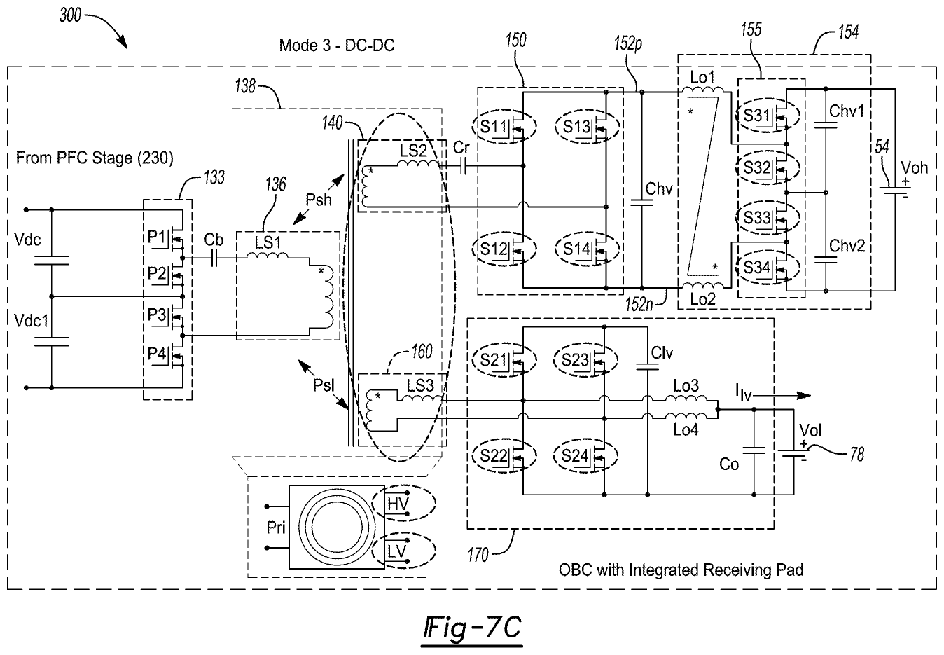

FIG. 7A shows a schematic diagram of the third power converter circuit 300 operating in an onboard charger (OBC) mode, in accordance with the present disclosure. In the OBC mode, power is transferred from the electrical grid to the HV battery 54. For example, power may be transferred from the 3-phase AC source 120 for charging the HV battery 54. All three ports (i.e. AC power from the 3-phase AC source 120. DC power to/from the HV output terminals 162p, 162n coupled to the HV battery 54, and DC power to/from the LV DC bus 170p, 170n coupled to the LV battery 78) may be actively controlled. For example, the controller 80 may actively control power transfer on each of the ports by controlling the operation of one or more sets of FETs in the third power converter circuit 300.

In the OBC mode, the seventh FETs P₁, P₂, P₃, P₄ of the second inverter stage second 133, the eighth FETs S₁₁, S₁₂, S₁₃, S₁₄ of the second HV power converter 150, and the ninth FETs S₃₁, S₃₂, S₃₃, S₃₄ of the step up/down converter 155 are each active. All other FETs of the third power converter circuit 300 may be inactive and in a de-energized state. The HV battery 54 may have a first nominal voltage or a second nominal voltage that is substantially greater than the second nominal voltage. For example, the first nominal voltage may be 400 V. and the second nominal voltage may be 800 V. This may allow third power converter circuit 300 to be used with different battery packs having different configurations or capacities. For an HV battery 54 having the first nominal voltage (e.g. a 400V battery), FETs S₃₂ and S₃₃ of the step up/down converter 155 are in a non-conductive state, while FETs S₃₁, and S₃₄ of the step up/down converter 155 are in a conductive state, for transferring power from the DC intermediate conductors 152p, 152n directly to the HV battery 54, without changing a voltage therebetween. For an HV battery 54 having the second nominal voltage (e.g. an 800V battery), all of the ninth FETs S₃₁, S₃₂, S₃₃, S₃₄ of the step up/down converter 155 are actively controlled to receive power from the DC intermediate conductors 152p, 152n at a given DC voltage and to increase (i.e. boost) and to supply power to the HV battery 54 at a higher voltage than the given DC voltage. Energy is transferred in the WPT transformer 138 between the OBC coil 136 (i.e. the primary coil) and the first coil 140 (i.e. the HV coil). A very high frequency AC power may be used to transmit the power in the WPT transformer 138. For example, the second inverter stage 133 may be configured to generate the AC power at a very high frequency. The very high frequency may be, for example, 260 kilohertz (kHz), phase shift controlled. However, other frequencies and/or control techniques may be used.

FIG. 7B shows a schematic diagram of the third power converter circuit 300 operating in a wireless power transfer (WPT) mode. In the WPT mode, power is transferred wirelessly from WPT transceiver 190 to the HV battery 54. Some or all of the ninth FETs S₃₁, S₃₂, S₃₃, S₃₄ of the step up/down converter 155 may be operated to regulate power supplied to the HV battery 54. For example, the controller 80 may actively control operation of the ninth FETs S₃₁, S₃₂, S₃₃, S₃₄ to operate the step up/down converter 155 for duty cycle control to regulate power supplied for charging the HV battery 54. The step up/down converter 155 may be operated at a high frequency, which may be, for example, 40 KHz, although other frequencies may be used.

In the WPT mode, the seventh FETs P₁, P₂, P₃, P₄ of the second inverter stage second 133 are each in a non-conducting mode, and the eighth FETs S₁₁, S₁₂, S₁₃, S₁₄ of the second HV power converter 150, and the ninth FETs S₃₁, S₃₂, S₃₃, S₃₄ of the step up/down converter 155 are each active. The eighth FETs S₁₁, S₁₂, S₁₃, S₁₄ of the second HV power converter 150 are operated in a synchronous rectifier mode. For an HV battery 54 having the first nominal voltage (e.g. a 400V battery). FETs S₃₂ and S₃₃ of the step up/down converter 155 are in a non-conductive state, while FETs S₃₁, and S₃₄ of the step up/down converter 155 are in a conductive state, for transferring power from the DC intermediate conductors 152p, 152n directly to the HV battery 54, without changing a voltage therebetween. For an HV battery 54 having the second nominal voltage (e.g. an 800V battery), all of the ninth FETs S₃₁, S₃₂, S₃₃, S₃₄ of the step up/down converter 155 are actively controlled to receive power from the DC intermediate conductors 152p, 152n at a given DC voltage and to increase (i.e. boost) and to supply power to the HV battery 54 at a higher voltage than the given DC voltage. Energy is transferred to the first coil 140 (i.e. the HV coil) of the WPT transformer 138 from the WPT transceiver 190 via loose magnetic coupling. The OBC coil 136 and the second coil 160 may be off or unused in the WPT mode. For example, each of the OBC coil 136 and the second coil 160 may be connected to an open circuit, preventing current flow therein.

FIG. 7C shows a schematic diagram of the third power converter circuit 300 operating in a DC-DC converter mode (DC-DC) mode, in accordance with the present disclosure. The DC-DC mode may also be called an auxiliary power module (APM) mode, because it allows power to be provided from the HV battery 54 to supplement and/or to charge the LV battery 78.

In the DC-DC mode, the seventh FETs P₁, P₂, P₃, P₄ of the second inverter stage second 133 are each in a non-conducting mode, the second HV power converter 150, and the LV power converter 170 work together to deliver power from the HV battery 54 to the LV battery 78. The eighth FETs S₁₁, S₁₂, S₁₃, Sis of the second HV power converter 150 are operated as an inverter to supply AC power to the first coil 140 of the WPT transformer 138. The tenth FETs S₂₁, S₂₂, S₂₃, S₂₄ of the LV power converter 170 are operated as a synchronous rectifier to convert AC power induced in the second coil 160 of the of the WPT transformer 138 to deliver power to the LV battery 78. For an HV battery 54 having the first nominal voltage (e.g. a 400V battery), FETs S₃₂ and S₃₃ of the step up/down converter 155 are in a non-conductive state, while FETs S₃₁, and S₃₄ of the step up/down converter 155 are in a conductive state for transferring power from the HV battery 54 directly to the DC intermediate conductors 152p, 152n, without changing a voltage therebetween. For an HV battery 54 having the second nominal voltage (e.g. an 800V battery), all of the ninth FETs S₃₁, S₃₂, S₃₃, S₃₄ of the step up/down converter 155 are actively controlled to receive power from the HV battery 54 and to supply power to the second HV power converter 150 via the DC intermediate conductors 152p, 152n. The step up/down converter 155 may be actively controlled to decrease (i.e. to buck) the battery voltage and to supply power to the second HV power converter 150 at a lower voltage than the battery voltage.

A very high frequency AC power may be used to transmit the power in the WPT transformer 138. For example, the second HV power converter 150 may be configured to generate the AC power at a very high frequency. The very high frequency may be, for example, 260 kHz, phase shift controlled. However, other frequencies and/or control techniques may be used.

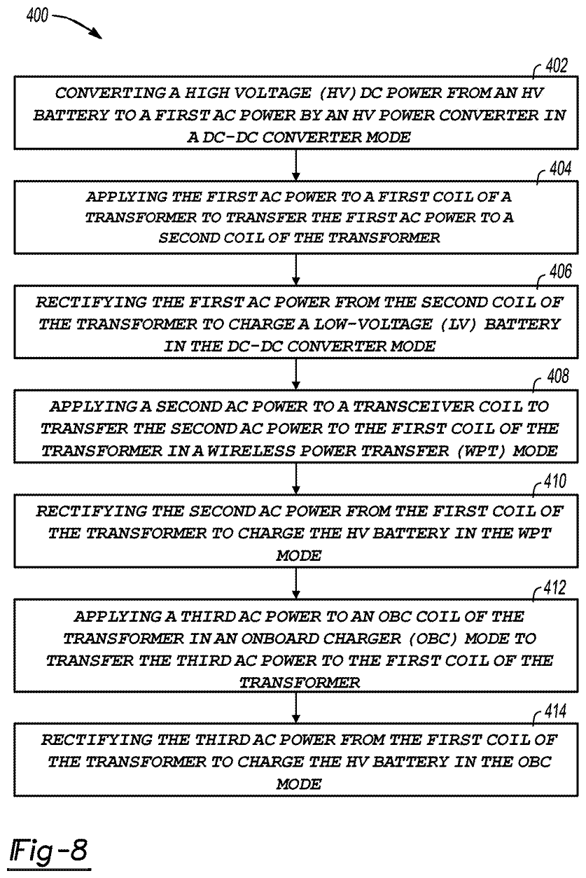

A method 400 of operating a charger circuit for a vehicle is shown in the flow chart of FIG. 8. The charger circuit may include, for example, third power converter circuit 300. The method 400 may be performed using instructions stored in the memory 84 of the controller 80 that, when executed by the processor 82 cause one or more devices, such as FETs or other switching devices of the third power converter circuit 300 to perform various actions.

The method 400 includes converting a high voltage (HV) direct current (DC) power from an HV battery to a first alternating current (AC) power by an HV power converter in a DC-DC converter mode at step 402. For example, the second HV power converter 150 may operate in an inverter mode to convert the HV DC power from the from the HV battery 54 to the first AC power in the DC-DC converter mode.

The method 400 also includes applying the first AC power to a first coil of a transformer to transfer the first AC power to a second coil of the transformer at step 404. For example, the second HV power converter 150 may supply the first AC power to the first coil 140 of the WPT transformer 138 in the DC-DC converter mode.

The method 400 also includes rectifying the first AC power from the second coil of the transformer to charge a low-voltage (LV) battery in the DC-DC converter mode at step 406. For example, the LV power converter 170 may be operated as a rectifier to convert AC power induced in the second coil 160 of the of the WPT transformer 138 to deliver power to the LV battery 78.

The method 400 also includes applying a second AC power to a transceiver coil to transfer the second AC power to the first coil of the transformer in a wireless power transfer (WPT) mode at step 408. In some embodiments, the transceiver coil may be magnetically coupled to the transformer and separated therefrom by an air gap. For example, the WPT inverter 192 may apply the second AC power to the WPT transceiver 190 in the WPT mode.

The method 400 also includes rectifying the second AC power from the first coil of the transformer to charge the HV battery in the WPT mode at step 410. For example, the second HV power converter 150 may rectify the second AC power from the first coil 140 of the WPT transformer 138 in the WPT mode.

The method 400 also includes applying a third AC power to an OBC coil of the transformer in an onboard charger (OBC) mode to transfer the third AC power to the first coil of the transformer at step 412. For example, the second inverter stage 133 may apply the third AC power to the OBC coil 136 of the WPT transformer 138 in the OBC mode.

In some embodiments step 412 further includes converting, by a power factor correction (PFC) stage, an input AC power to an intermediate DC power. The PFC stage may have a high power factor. The second PFC stage 130 and/or the third PFC stage 230 may operate in a single-phase mode or a three-phase mode to perform this conversion.

In some embodiments step 412 further includes converting the intermediate DC power to the third AC power. For example, the second inverter stage 133 may convert the intermediate DC power from the second PFC stage 130 to the third AC power.

The method 400 also includes rectifying the third AC power from the first coil of the transformer to charge the HV battery in the OBC mode at step 414. For example, the second HV power converter 150 may rectify the third AC power from the first coil 140 of the WPT transformer 138 in the OBC mode

The system, methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices as well as heterogeneous combinations of processors processor architectures, or combinations of different hardware and software, or any other machine capable of executing program instructions.

Thus, in one aspect, each method described above and combinations thereof may be embodied in computer executable code that, when executing on one or more computing devices performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A charger circuit for a vehicle, comprising:
a transformer having a first coil and a second coil, with each of the first coil and the second coil being magnetically coupled for transmitting power therebetween;
a high-voltage power converter connected to the first coil and configured to charge a high-voltage (HV) battery connected thereto;
a low-voltage power converter connected to the second coil and configured to charge a low-voltage (LV) battery connected thereto;
wherein the charger circuit is operable in a DC-DC conversion mode to transfer power from the HV battery to charge the LV battery; and
wherein the charger circuit is operable in a wireless power transfer (WPT) mode to receive power induced in the first coil, from a WPT transceiver, to charge the HV battery.

2. The charger circuit of claim 1, further comprising:
a power factor correction (PFC) stage configured to convert an alternating current (AC) input power to a direct current (DC) power on a DC bus; and
an inverter stage coupled to the DC bus and configured to generate a high-frequency AC power upon a first set of AC conductors;
wherein the transformer further includes an OBC coil connected to the first set of AC conductors and being magnetically coupled to each of the first coil and the second coil for transmitting power therebetween; and
wherein the charger circuit is further operable in an onboard charger (OBC) mode to transfer the input power to charge the high-voltage (HV) battery.

3. The charger circuit of claim 2, wherein the PFC stage includes a phase converter comprising:
an input node and a neutral node defining an alternating current (AC) voltage therebetween, the phase converter also having a DC positive conductor and a DC negative conductor;
two high-side FETs connected in series between the input node and the DC positive conductor and defining a high-side node therebetween;
two low-side FETs connected in series between the input node and the DC negative conductor and defining a low-side node therebetween;
a high-side diode having a cathode terminal and an anode terminal, the cathode terminal connected to the high-side node and the anode terminal connected to the neutral node; and
a low-side diode having a cathode terminal and an anode terminal, the cathode terminal connected to the neutral node and the anode terminal connected to the low-side node.

4. A charger circuit for a vehicle, comprising:
a power factor correction (PFC) stage including an input node, a DC positive conductor, a DC negative conductor, a DC middle conductor, and at least one phase converter configured to receive AC power from the input node and to supply DC power on the DC positive conductor and on the DC middle conductor, with the DC middle conductor having a DC voltage between voltages of the DC positive conductor and the DC negative conductor, the at least one phase converter including:
two high-side power semiconductor devices connected in series between the input node and the DC positive conductor and defining a high-side node therebetween;
two low-side power semiconductor devices connected in series between the input node and the DC negative conductor and defining a low-side node therebetween;
a first semiconductor device connected between the high-side node and the DC middle conductor for regulating a current flow therebetween; and
a second semiconductor device connected between the low-side node and the DC middle conductor for regulating a current flow therebetween.

5. The charger circuit of claim 4, wherein at least one of the high-side power semiconductor devices includes a Gallium nitride (GaN) field-effect transistor (FET).

6. The charger circuit of claim 4, wherein at least one of the low-side power semiconductor devices includes a Gallium nitride (GaN) field-effect transistor (FET).

7. The charger circuit of claim 4, wherein at least one of the first semiconductor device and the second semiconductor device is a diode.

8. The charger circuit of claim 4, wherein at least one of the first semiconductor device and the second semiconductor device is a transistor.

9. The charger circuit of claim 8, wherein the transistor is a Gallium nitride (GaN) field-effect transistor (FET).

10. The charger circuit of claim 4, wherein the DC middle conductor has a DC voltage, referenced to the DC negative conductor, equal to one-half of a DC voltage of the DC positive conductor, referenced to the DC negative conductor.

11. The charger circuit of claim 4, wherein the at least one phase converter includes three phase converters, with each of the three phase converters configured to rectify power from a corresponding phase of a three-phase AC supply.

12. A method of operating a charger circuit for a vehicle, comprising:
converting a high voltage (HV) direct current (DC) power from an HV battery to a first alternating current (AC) power by an HV power converter in a DC-DC converter mode;
applying the first AC power to a first coil of a transformer to transfer the first AC power to a second coil of the transformer;
rectifying the first AC power from the second coil of the transformer to charge a low-voltage (LV) battery in the DC-DC converter mode;
applying a second AC power to a transceiver coil to transfer the second AC power to the first coil of the transformer in a wireless power transfer (WPT) mode, with the transceiver coil magnetically coupled to the transformer and separated therefrom by an air gap; and
rectifying the second AC power from the first coil of the transformer to charge the HV battery in the WPT mode.

13. The method of claim 12, further comprising:
applying a third AC power to an OBC coil of the transformer in an onboard charger (OBC) mode to transfer the third AC power to the first coil of the transformer; and
rectifying the third AC power from the first coil of the transformer to charge the HV battery in the OBC mode.

14. The method of claim 13, wherein applying the third AC power to the OBC coil further comprises:
converting, by a power factor correction (PFC) stage, an input AC power to an intermediate DC power; and
converting the intermediate DC power to the third AC power.

15. The method of claim 14, wherein the PFC stage includes a plurality of Gallium nitride (GaN) field-effect transistors (FETs) for converting the input AC power to the intermediate DC power.
